(19) United States
(12) Patent Application Publication
(10) Pub. No.: US 2024/0157381 A1
(43) Pub. Date: May 16, 2024

(54) SUPERSONIC NOZZLE FOR DECONTAMINATION AND/OR DISINFECTION

(71) Applicant: COUNTERFOG SL, Madrid (ES)

(72) Inventors: Francisco Javier PÉREZ DEL ÁLAMO, Madrid (ES); Juan SÁNCHEZ GARCÍA CASARRUBIOS, Madrid (ES)

(21) Appl. No.: 17/990,159

(22) Filed: Nov. 18, 2022

(30) Foreign Application Priority Data
Nov. 8, 2022 (ES) P202230959

(51) Int. Cl. B05B 7/00; B05B 17/04

(52) U.S. Cl. CPC B05B 7/0012; B05B 17/04

(57) ABSTRACT

A nozzle assembly that includes an outlet conduit that exhaust to the environment, a rear sub-chamber, a liquid inlet that opens into the rear sub-chamber, a front sub-chamber in fluid communication with both the outlet conduit and the rear sub-chamber and a dividing member disposed between the front and rear sub-chambers. The dividing member includes fluid passages that provide fluid communication between the front and rear sub-chambers. The nozzle also includes an air inlet conduit configured to deliver a pressurized supersonic air stream into the front sub-chamber. The parts of the nozzle assembly are configured to give rise to first, second and third atomization stages that respectively occur in the rear sub-chamber, the front sub-chamber and at the outlet conduit.

### CROSS-REFERENCE TO RELATED APPLICATIONS

This application relates to and claims the benefit and priority to Spanish Patent Application No. P202230959, filed Nov. 8, 2022.

### FIELD

The present invention relates to apparatus and methods used for decontamination and disinfection purposes.

### BACKGROUND

Atomization of a liquid into fine droplets has a large number of industrial applications including, for instance, moisting, painting, injecting, cleaning, coating, lubrication, dust control, humidification, fire protection, cooling solids, gas cooling, washing and conditioning, covering and for decontaminating, capturing, or sampling air-borne particles—including for example smoke, viruses, and spores.

Droplet size, geometry and dynamics of flow and spatial distribution are essential for particular purposes like decontamination of micron and submicron-sized air-borne particles or for the sampling of aerosols. For example U.S. patent application Ser. No. 17/687,066 discloses a method and apparatus for capturing and sampling air-borne particles using a jet of fog. Also, as an example air decontamination based on the use of jets of fog generated with nozzles was described by Perez-Diaz et al. in 2019 “Decontamination of Diesel particles from air by using the Counterfog® system. Air Quality, Atmosphere & Health. 12. 10.1007/s11869-018-00656-7”. In this particular application the size of the droplets conditions the effectiveness. Only droplets smaller than the air-borne particles can collapse and aggregate to them. Therefore, to remove the finest airborne particles smaller than a micron, it is necessary to generate jets of fog made of droplets smaller than or of the order of airborne particles. For instance, SARS-Cov-2 has a diameter around 125 nm and Anthrax spores have a diameter of around 800 nm.

A variety of nozzle designs and sizes are available to produce fine droplets. In direct pressure nozzles, the fluid is broken (atomized) into droplets by impact on a surface or by the high shear force caused by the fluid passing through a shaped orifice, as in U.S. Publication No. 2006/0196967 A1. The energy required for atomization comes from the energy of the fluid itself.

By contrast, atomizing nozzles based on the mixture of two fluids, air (or other gas) and liquid, represent a more efficient option since their operation is based on the speed and pressure gradient between the gas at high speed and an injected or aspirated liquid (Venturi effect) at low speed and low pressure. These different relative speeds between gas and liquid phases are key for atomizing viscous media at low pressures. This means that the energy required for atomization is independent to the fluid pressure, allowing fine atomization at low fluid pressures. However, producing fine droplets from liquids by mixing gas and liquid in a nozzle involves complex phenomena which are not yet fully understood. This lack of knowledge has prevented an efficient optimization of droplet sizes and output velocity. Uniform high-speed aerosol patterns are not achievable with the current state of the art. In general, current devices are able to produce small droplets only at low discharge speed. Therefore, they proved to suffer from drift and, consequently, are ineffective for the majority of applications.

In recent years, improvements in atomization efficiency have been proposed through the use of Laval geometries as Zhang T et al. teach in “Supersonic antigravity aerodynamic atomization dusting nozzle based on the Laval nozzle and probe jet. J Braz Soc Mech Sci Eng 2020; 42: 335”. This dedicated profile (so called Laval profile), widely used in nozzles for rocket engines, accelerates from subsonic to supersonic regime a gas flow through a throat that communicates the convergent inlet to the divergent outlet. Its use presents serious limitations because liquid cannot reach the supersonic region and cannot combine with the supersonic air in an optimum way as Cavaliere P. explained in 2015 in “Cold spray coating technology for metallic components repairing. through-life engineering services. Springer International Publishing, Berlin. DOI:10.1007/978-3-319-12111-6_11”. Consequently, the air-water mixing is only performed in the divergent outlet (expansion process) and always outside the nozzle. Any expansion process implies a temperature drop, any liquid, under these conditions, increases its surface tension so the atomization becomes inefficient.

There are alternatives to mitigate this constraint by attempting partial pre-atomization prior to convergent entry before reaching supersonic speeds, for example, by using annular/coaxial geometries in the liquid and air discharge, as disclosed in U.S. Pat. Nos. 5,520,331 and 3,534,909. Another alternative is the use of ultrasonic vibrating pins as Hong et al. explained in 2011 in “Resonant behaviors of ultrasonic gas atomization nozzle with zero mass-flux jet actuator. J Shanghai Univ (English Edition) 15(3):166-172”. However, as the pre-atomization alternatives are not perfect, the inefficient droplet size distribution with large droplets generates strong decelerations and a non-uniform discharge flow both in speed and spatial distribution, which in any case, does not reach nanometer sizes and is too large to be considered as an aerosol distribution.

The results of these partial solutions are not efficient enough due to the complexity of the solution itself, the complex manufacturing of the nozzle as Cai et al. teach in “Optimum end milling tool path and machining parameters for micro-Laval nozzle manufacturing. Proceedings of the Institution of Mechanical Engineers, Part B: Journal of Engineering Manufacture. 231. 10.1177/0954405415608601” or the additional energy consumption in case of using ultrasonic pre-atomization. The generation of aerosols at high discharge speeds is still a real challenge today.

### SUMMARY

Disclosed herein are nozzles that solve the problems discussed above by means of an efficient mixing of a gas (e.g. air) and a liquid (e.g. water) achieved by means of first, second and third atomization stages. The first atomization stage occurs in a rear sub-chamber of the nozzle and the second atomization stage occurs in a front sub-chamber of the nozzle. The front and rear sub-chambers are separated by a dividing member. The dividing member includes two or more fluid passages that extend along an entire axial length of the dividing member, the two or more fluid passages provide fluid communication between the front and rear sub-chambers. According to one implementation, in the first atomization stage the rear sub-chamber is used to mix a low-pressure axial water stream with air proceeding from the front sub-chamber creating a mist/fog/aerosol (e.g. water droplets suspended in air) distribution in the rear sub-chamber. The air proceeding from the front sub-chamber enters the rear sub-chamber through one or more first fluid passages located in the dividing member. The second atomization stage involves a mist/fog generated in the rear sub-chamber being introduced into the front sub-chamber by one or more second fluid passages in the dividing member and further atomizing the liquid in the incoming mist/fog to create a new finer droplet distribution by use of a supersonic pressurized air flowing into the front sub-chamber. The high gradient of velocity associated to the supersonic front very efficiently breaks the liquid droplets. Finally, the fine mist/fog produced in the front sub-chamber during the second atomization stage is accelerated to supersonic speeds in the third atomization stage by means of a narrow nozzle outlet conduit having an outlet diameter that is equal to or less than one-half its length. (This avoids the need to apply Laval geometries.) As a result, a generally uniform and anti-drift supersonic expansion cone of aerosol/fog is jetted from the nozzle with an ability to suppress chemical, biological, nuclear, and radiological (CBRN) aerosol from the air external to the nozzle. “Anti-drift” meaning the supersonic aerosol expansion cone created at the outlet of the nozzle has an inertia that is not easily affected by air flow external to the nozzle.

In the examples provided herein, the dividing member is a disk. It is appreciated, however, that the dividing member need not comprise a cylindrical shape. Rectangular and other shapes are also contemplated. The dividing member need only facilitate flow between the front and rear sub-chambers as disclosed herein in order that the first, second and third atomization stages take place upon a designated flow of gas (e.g. air) and a designated flow of liquid (e.g. water) is delivered respectively to the front and rear sub-chambers.

As will be described in more detail below, according to some implementations the dividing member is a slotted disk that includes slots/grooves formed in an outer circumferential wall of the disk, the slots/grooves extending entirely across the axial length of the disk to fluidly communicate the front and rear sub-chambers with one another. In lieu of or in conjunction with the slots/grooves, the dividing member (e.g. disk) may include through holes located near a peripheral edge of the disk through which the front and rear sub-chambers communicate. In the context of the present disclosure, “located near a peripheral edge” means the through holes are located nearer the peripheral edge of the disk than to the axial center of the disk.

According to some implementations, the axial position of the dividing member within the nozzle may be adjusted to alter the volume of the front and rear sub-chambers for the purpose of altering the jet produced at the outlet of the nozzle 100.

The use of slotted disks as internal parts in atomizing nozzles is well known, Examples are found in U.S. Pat. Nos. 5,692,682 and 7,611,080 and in U.S. Publication Nos. 2003/0146301 A1 and US2015/0028132 A1. All of them with the function of inducing a spin or tangential component added to the axial velocity of a liquid, a gas or a mixture of both. These slotted disks or swirls need a relatively large diameter to add a tangential component (inertial momentum) not negligible compared to the axial one. U.S. Pat. No. 7,243,861 B2 is an example application in this regard. It discloses a divergent part, a disk with a diameter taking up between 5 mm and 10 mm with passages which are oblique and/or in the form of helical portions with a “total area” “of between about 3 mm² and about 15 mm² for inducing rotation in water.

In the case of atomizing nozzles based on supersonic discharge, the use of spin-inducing slotted disks is meaningless, all induced spin is cancelled out in the acceleration process to supersonic speeds (axial component predominates). The present invention may employ a smaller diameter slotted disk than used in the present state of the art for reason that it is not required to drive a tangential component to the fluid. For example, slotted disks of less than 5 mm in diameter with helical indentations of less than 3 mm² in cross-section may be used. A main function of the slotted disk of the present invention is to modify the volume of the front and rear sub-chambers allowing interconnection between them in order to optimize the supersonic aerosol droplet size distribution discharged into the environment.

Nozzles used for decontamination or disinfection may become contaminated by contact with the contaminated environment, particularly with air. The anti-drift supersonic aerosol expansion cone created by use of the supersonic nozzles disclosed herein diminishes or eliminates the flow of contaminates into the interior of the nozzle.

These and other advantages and features will become apparent in view of the drawings and the detailed description.

### BRIEF DESCRIPTION OF THE DRAWINGS

FIG. 1 illustrates a cross-section side view of a supersonic nozzle according to one implementation.

FIG. 2 illustrates the supersonic nozzle of FIG. 1 with the dividing member located in a different axial position.

FIG. 3A is a view of a dividing member according to one implementation.

FIG. 3B is a view of a dividing member according to another implementation.

FIG. 4 illustrates example flowlines of compressed air and mist in the sub-chambers, disk slots and outlet of the supersonic nozzle of FIG. 1.

FIG. 5 is a greyscale graph illustrating an example magnitude of the fluid speed in the sub-chambers, disk slots and outlet mouth of the supersonic nozzle of FIG. 1. The scale is adjusted so that supersonic regions are approximately represented as white.

FIG. 6 is a side cross-section view of a nozzle assembly according to one implementation.

### DETAILED DESCRIPTION

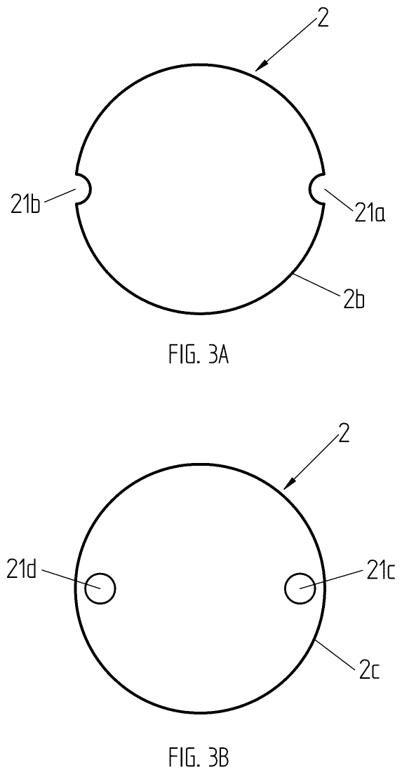

A supersonic nozzle according to one implementation comprises an atomizing chamber 1 (which may be drilled as a cylindrical hole) with a dividing member 2 inserted in it dividing the atomizing chamber into a front sub-chamber 1a and a rear sub-chamber 1b. In the examples provided herein, the dividing member 2 is a disk as shown in FIGS. 3A and 3B. As explained above, the dividing member 2 need not comprise a cylindrical shape. Rectangular and other shapes are also contemplated. The dividing member 2 need only facilitate flow between the front and rear sub-chambers 1a and 1b as disclosed herein in order that the first, second and third atomization stages take place upon a designated flow of gas (e.g. air) and a designated flow of liquid (e.g. water) being respectively delivered into the front and rear sub-chambers. In the implementation of FIG. 3A, the dividing member 2 is a slotted disk that includes slots/grooves 21a and 21b formed in an outer circumferential wall 2b of the disk, the slots/grooves extending entirely across the axial length of the disk to fluidly communicate the front and rear sub-chambers with one another. These slots/grooves 21a and 21b may be of a different flow cross section. In lieu of or in conjunction with the use of slots/grooves, the dividing member 2 (e.g. disk) may include through holes 21c and 21d located near a peripheral edge 2c of the disk 2 as shown in FIG. 3B through which the front and rear sub-chambers communicate. Again these holes 21c and 21d may be of a different flow cross section.

According to one implementation, the front sub-chamber 1a is provided with a lateral narrow compressed air inlet conduit 3 that opens into the front sub-chamber. The air inlet conduit 3 has a diameter D1 substantially smaller than its length L1. According to some implementations the air inlet conduit 3 is cylindrical and has a diameter D1 that is equal to or less than half its length L1. According to some implementations D1 ranges from 0.3 mm to 1.1 mm and L1 ranges from 2.0 mm to 4.5 mm. According to some implementations, the air inlet conduit 3 has a central longitudinal axis “LA” that is arranged perpendicular to the nozzle axis “NA”. According to other implementations (not shown), the air inlet conduit 3 has a central longitudinal axis “LA” that is arranged oblique to the nozzle axis “NA”. The front sub-chamber 1a also fluidly communicates with a narrow outlet conduit 4 that exhaust to the environment. Like air inlet conduit 3, the narrow outlet conduit 4 also has diameter substantially smaller than its length. In addition, the diameter of the narrow outlet conduit 4 is greater than the diameter of the air inlet conduit 3. According to some implementations the outlet conduit 4 is cylindrical and has a diameter D2 equal to or less than one-half its length L2. The cross section of the narrow outlet conduit 4 is greater than the cross-section of the air inlet conduit 3 to cause the compressed air to have a first expansion when entering the front sub-chamber 1a and a second expansion when exiting the narrow outlet conduit 4. Moreover, air pressure is provided (typically between 4 and 12 bar) to generate first and second supersonic discharges: the first supersonic discharge occurring at the outlet of air inlet conduit 3 into the front sub-chamber 1a and the second supersonic discharge being from the front sub-chamber 1a out through the narrow outlet conduit 4. Typically pressure drops by 1 to 2 bar in the first supersonic discharge from the air inlet conduit 3 into the front sub-chamber 1a while pressure drops to almost atmospheric pressure in the second supersonic discharge from the front sub-chamber la out through the narrow outlet conduit 4 generating a jet of fog. According to some implementations D2 ranges from 0.5 mm to 1.5 mm and L2 ranges from 0.6 mm to 4.0 mm. According to some implementations, the ratio of D2/D1 is in a range of 0.8 to 1.4.

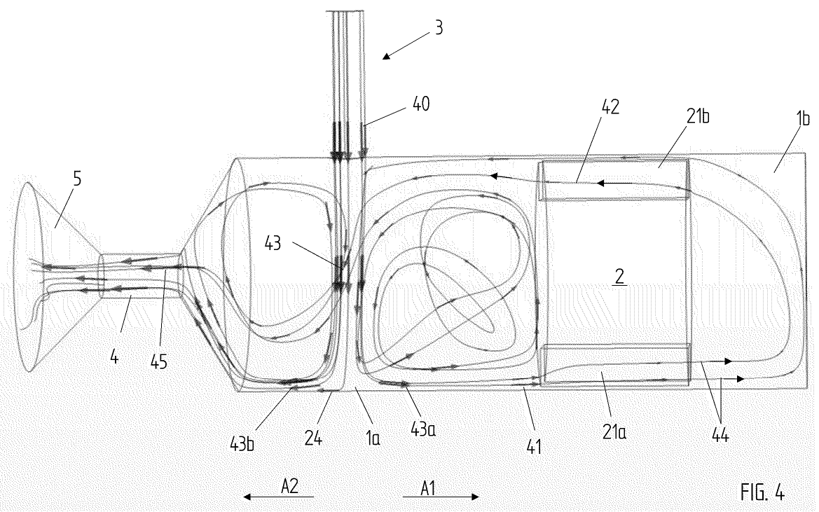

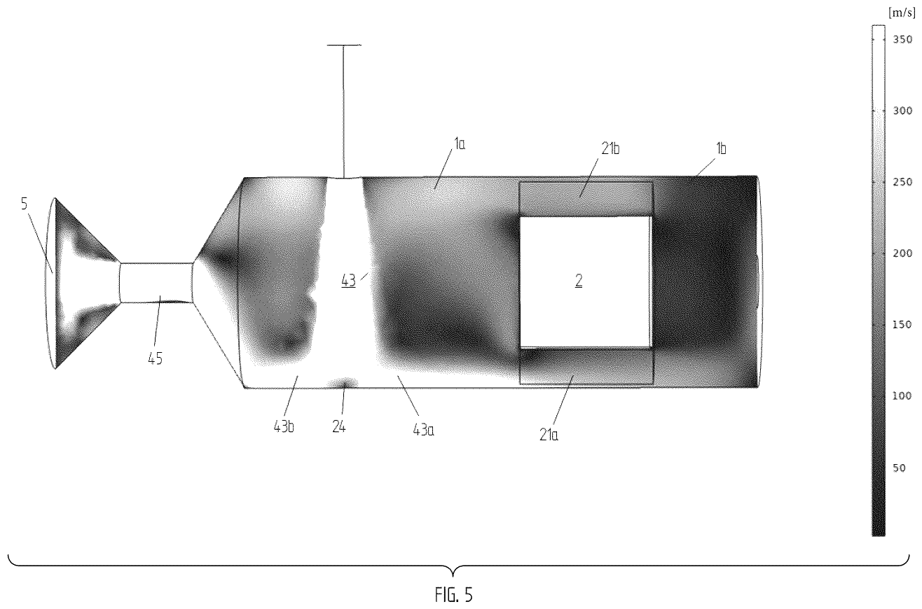

The nozzle 100 is configured such that when compressed air 40 is delivered into the front sub-chamber, the compressed air partially penetrates from the front sub-chamber 1a into the rear sub-chamber 1b through one or more first slots 21a (and/or first holes 21c) and returns to the front sub-chamber 1b back through one or more second slots 21b (and/or second holes 21d). According to one implementation the disk 2 includes only two slots (or two holes), a first slot 21a (or hole 21c) through which pressurized air/gas 41 passes from the front sub-chamber 1a to the rear sub-chamber and a second slot 21b (or hole 21d) through which a mist 42 generated in the rear sub-chamber 1b passes to the front sub-chamber 1a. Typically, the supersonic air flow 43 coming into the front sub-chamber from the air inlet conduit 3 collides with a wall 24 of the front sub-chamber 1a. According to some implementations, the wall 24 is located opposite the entry location of the supersonic air flow (i.e. at the outlet of air inlet conduit 3). As illustrated in FIG. 4, the collision causes a first part of the supersonic air flow 43a to be directed in a first axial direction A1 towards the disk 2 and causes a second part of the supersonic air flow 43b to be directed in a second axial direction A2 towards a front end portion of the front sub-chamber 1a. With continued reference to FIG. 4, at least a portion of the A1 directed air penetrates through the one or more first slots 21a (or one or more first holes 21c) of disk 2 into the rear sub-chamber 1b where it mixes with a liquid (e.g. water) to produce a mist that migrates towards and flows through the one or more second slots 21b (or one or more second holes 21d) into the front sub-chamber 1a.

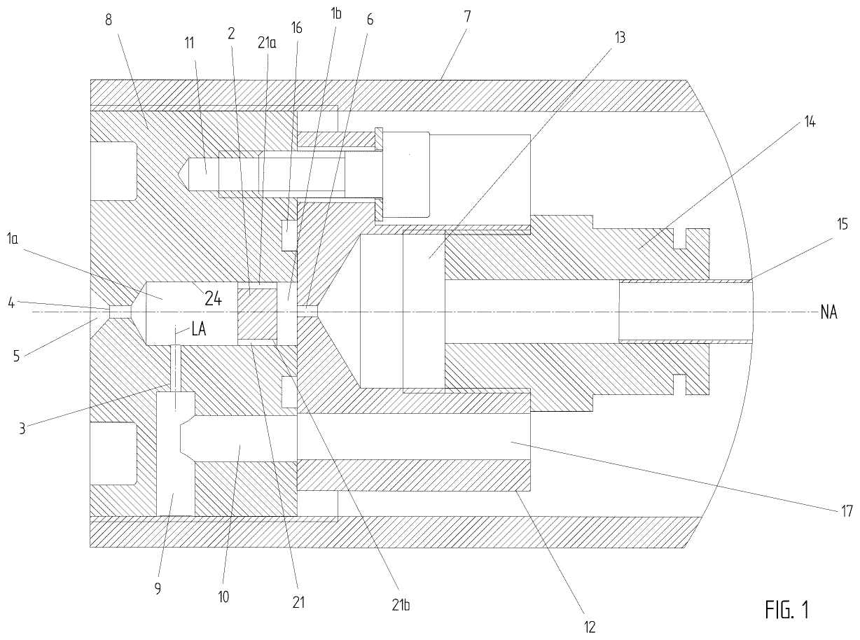

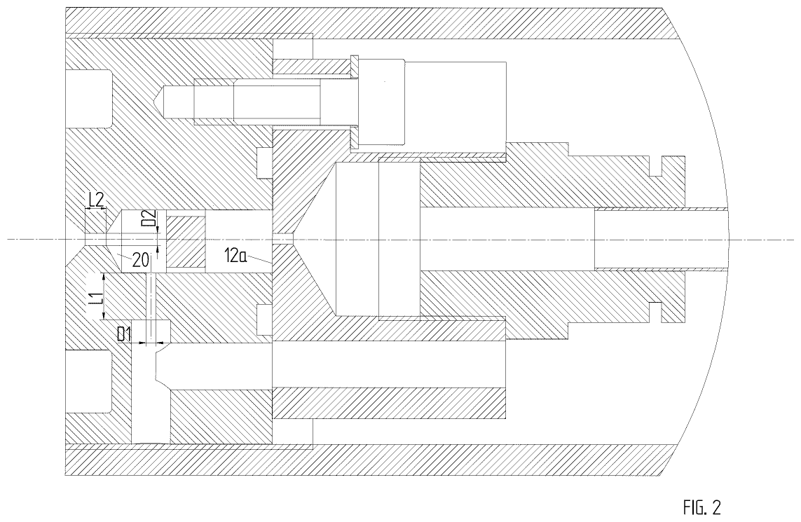

The rear sub-chamber 1b is provided with a liquid inlet 6 supplying liquid at a pressure greater than atmospheric pressure to be atomized by the air flow 44 in the rear sub-chamber 1b. A first atomization is achieved in the rear sub-chamber 1b as the liquid is mixed with the air flow therein. The number and size of liquid droplets generated in the rear sub-chamber 1b will be conditioned by the diameter of the liquid inlet 6, the supply pressure of the liquid at the liquid inlet 6, and the amount of air flow in the rear sub-chamber 1b. According to one implementation, the diameter of the liquid droplets in the rear sub-chamber is between 0.5 to 1 mm (when atomized). The air flow in the rear sub-chamber 1b is substantially slower than the supersonic air flow in the front sub-chamber 1a and can be altered/tuned by moving the axial location of the disk 2 along a length of the chamber 1. As an example, FIGS. 1 and 2 show the disk 2 at different axial locations. The air flow can also be altered/tuned by changing the number of slots or holes, changing the geometry or size of the slots or holes, or by changing their orientation (e.g. by slanting the slots or through holes).

The mist/fog 42 generated in the rear sub-chamber 1b flows into the front sub-chamber 1a through the one or more second slots 21b (or one or more second holes 21d). This mist/fog is drawn into the front sub-chamber 1a by the supersonic air flow coming in from the air inlet conduit 3 and breaking (or more precisely by bursting) the liquid droplets into much smaller ones. This causes a second atomization of the liquid droplets that homogenizes the properties of the mist/fog 45 as it passes through the narrow nozzle outlet conduit 4, and therefore homogenizes the properties of the jet of fog produced at the nozzle outlet. This second atomization is so effective that liquid droplets can be generated at the nozzle outlet with diameters as small as a few tens of nanometers (e.g. 40 to 50 nanometers).

The nozzle may be operated in a second mode to provide larger water droplets in the mist/fog that is generated out the outlet of the nozzle 100. In instances this may be advantageous, such as when it is necessary to cover a surface with water droplets. According to one implementation, this can be accomplished by increasing the liquid pressure and flow through the liquid inlet 6 to cause a filling of the rear sub-chamber 1b with the liquid. When operating in the second mode, the liquid in the rear sub-chamber 1b flows through some or all of the plurality of slots and/or holes of the disk 2 into the front sub-chamber 1a to be atomized therein by the flow of supersonic air entering the front sub-chamber via compressed air inlet 3. According to some implementations, when the nozzle is operated in the first mode as described above, a liquid (e.g. water) is delivered through the liquid inlet 6 at a pressure of 1 to 2 bar. According to some implementations, switching to the second mode may occur by increasing the liquid/water pressure in the liquid inlet 6. According to some implementations, a switching of operation from the first mode to the second mode occurs when the liquid/water in the liquid inlet 6 reaches a pressure of between about 4 bar to about 10 bar.

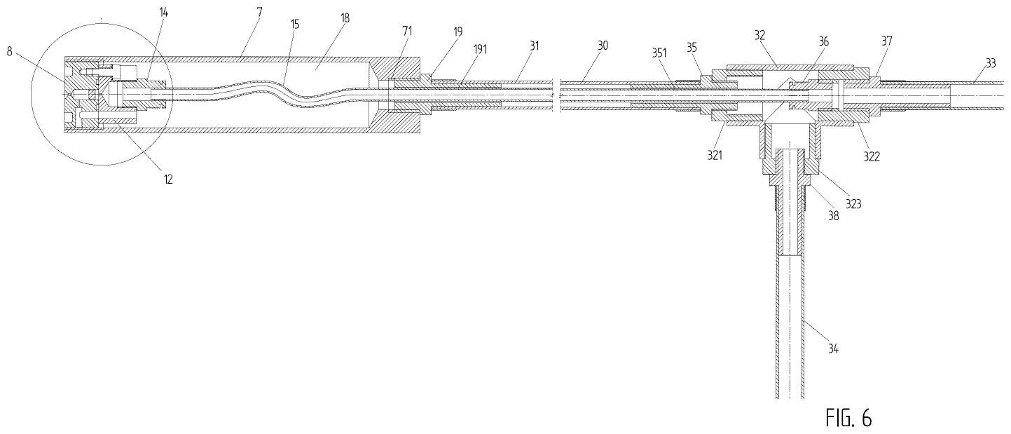

Turning now to FIG. 6, according to some implementation the supersonic nozzles disclosed and contemplated herein may reside inside a housing 7 that can be easily held and manipulated by a user. According to some implementations, the nozzle includes a plug 8 secured to a front end of housing 7. According to some implementations, the housing 7 and plug 8 are joined by a threaded connection. According to some implementations the plug 8 has a front face that is substantially flat and flush with a front border of the housing 7. This flat/flush arrangement makes it easier to clean and decontaminate the nozzle exterior surface after use.

According to some implementations, the front face of the plug 8 is provided with slots arranged with a hexagonal or square shape to facilitate the use of a socket wrench to tighten the plug 8 onto the housing 7.

According to some implementations, the front sub-chamber 1a is delimited by a back face of the plug 8. According to some implementations, the narrow outlet conduit 4 is disposed between an internal cylindrical or cone-shaped hole 20 and a conic outlet mouth 5. According to some implementations, the narrow outlet conduit 4 comprises a hole drilled into the front face of the plug 8 and the outlet mouth 5 and hole 20 respectively located in a front face and a back face of the plug are axially aligned. The configuration of the conic outlet mouth 5 determines the geometry of the jet of fog exiting the nozzle.

According to some implementations, a part of the nozzle includes a radial bore 9 through which compressed air is delivered to air inlet conduit 3. According to some implementations, the radial bore 9 has a cross-sectional area greater than the cross-sectional area of the air inlet conduit 3 so that the compressed air flowing through the radial bore flows sub-sonically. According to some implementations, each of the radial bore 9 and air inlet conduit 3 is cylindrical with the radial bore having a diameter greater than the diameter of the air inlet conduit. According to one implementation the air inlet conduit 3 has a diameter of 0.65 mm and produces approximately a 1,500 meters/second supersonic flow when compressed air is supplied to the air inlet conduit at 10 bar. According to such an implementation, when the diameter of the radial bore 9 is 2.5 mm, the compressed air flows sub-sonically through the radial bore at a speed of less than 100 meters/seconds.

According to some implementations, an axial air passage 10 is also drilled the rear face of the plug 8 connecting with the radial bore 9 so that the compressed air can flow through each of them sub-sonically. According to some implementations, the same diameter can be selected for both the radial bore 9 and the axial hole 10.

A set of female thread holes 11 open to the rear face of the plug 8 are provided according to the usual practice in mechanical engineering to fix a connector part 12 to plug 8. This connector part 12 is provided with a standardized female thread bore 13 where a standard fast connector 14 is provided to provide a fluid connection with a flexible pipeline 15 as shown in FIG. 6. According to some implementations, the liquid inlet 6 is drilled into the front face of the connector part 12 to enable the flow of liquid from the flexible pipeline 15 to the rear sub-chamber 1b. In such an implementation, a front face 12a of the connector part 12 partially delimits the rear sub-chamber 1b acting as a rear wall of the rear sub-chamber. As shown in FIG. 1, the connector part 12 may include an air conduit 17 that is in fluid communication with air passage 10. According to some implementations the connector part 12 is a monolithic structure that includes both a liquid conduit and an air/gas conduit. An O-ring or gasket 16 disposed between the connector part 12 and the plug 8 provides an air-tight seal between them.

With continued reference to FIG. 6, according to some implementations the housing 7 is provided with a thread hole 71 at its rear face where an external connector fitting 19 is screwed providing a fluid connection to a radially outer-most conduit 31 of a coaxial hose 30. The flexible pipeline 15 passes through a hole 191 in the external connector fitting 19 and constitutes the radially innermost conduit of the coaxial hose 30. Liquid is supplied through the flexible pipeline 15 while compressed air is supplied through the clearance between the flexible pipeline 15 and the outer-most hose 31 or the hole 191. The total cross section of such a clearance between the flexible pipeline 15 and the outer-most conduit 31 or the hole 191 is preferably large enough to cause the compressed air to flow at a subsonic speed with a low pressure drop. The coaxial hose 30 is flexible and long enough to enable the user to manipulate the housing 7 to arm the outlet of the nozzle towards any desired decontamination or disinfecting location.

According to some implementations a “T” fitting 32 is provided to merge a liquid supply line 33 and a compressed air supply line 34. The flexible pipeline 15 passes through a hole 351 in an external connector fitting 35 connected to a first branch 321 of the “T” fitting 32, to finally be connected with a standard fast connector 36 screwed internally to the thread of a second branch 322 of the “T” fitting 32. A liquid connector fitting 37 screwed externally to the thread of the second branch 322 of the “T” fitting 32 is connected to the liquid supply line 33 arranged so that liquid is supplied to the flexible pipeline 15. Additionally, a compressed air connector fitting 38 is connected to a third branch 323 of the “T” fitting 32 to provide compressed air from the compressed air supply line 34.

It is important to note that the functioning of the nozzle 100 is in no way limited to a liquid and gas delivery system as disclosed in the preceding three paragraphs. Any gas and liquid delivery system can be used in conjunction with the nozzle 100, so long as an achievement of the first, second and third atomization stages as disclosed herein is capable of being met when the nozzle 100 is operated in the first mode.

Exemplary implementations have been disclosed and described herein. It is to be appreciated however, that the present invention is in no way to be construed as to being limited to these examples.

What is claimed is:

1. A nozzle assembly comprising:
an outlet conduit that exhaust to the environment;
a rear sub-chamber;
a liquid inlet that opens into the rear sub-chamber;
a front sub-chamber in fluid communication with both the outlet conduit and the rear sub-chamber;
a dividing member disposed between the front and rear sub-chambers, the dividing member including at least first and second fluid passages, the first fluid passage being configured to transport air from the front sub-chamber to the rear sub-chamber, the second fluid passage being configured to transport a first mist comprising an air and liquid mixture from the rear sub-chamber to the front sub-chamber; and
an air inlet conduit configured to deliver a pressurized supersonic air stream into the front sub-chamber, the air inlet conduit having an outlet that faces a wall of the front sub-chamber, the air inlet conduit and the front sub-chamber being configured such that upon pressurized air being introduced into the air inlet conduit, the generated pressurized supersonic air stream strikes the wall of the front sub-chamber and is divided into first and second air streams that flow in respective first and second directions, the first direction being towards the outlet conduit, the second direction being towards the first fluid passage of the dividing member, the first fluid passage configured to permit air in the second air stream to proceed into the rear sub-chamber.

2. The nozzle assembly according to claim 1, wherein the outlet conduit, the rear sub-chamber, the liquid inlet, the front sub-chamber, the dividing member, and the air inlet conduit are configured such that upon the pressurized air being introduced into the air inlet conduit and a liquid being introduced into the liquid inlet, a first atomization of the liquid occurs in the rear sub-chamber by the air proceeding into the rear sub-chamber.

3. The nozzle assembly according to claim 2, wherein the first atomization of the liquid in the rear sub-chamber creates the first mist in the rear sub-chamber, the outlet conduit, the rear sub-chamber, the liquid inlet, the front sub-chamber, the dividing member, and the air inlet conduit are configured such that after the pressurized air is introduced into the air inlet conduit and the liquid is introduced into the liquid inlet, the first mist flows through the second fluid passage of the dividing member into the front sub-chamber and a second atomization of the liquid in the first mist is caused by the pressurized supersonic air stream to create a second mist inside the front sub-chamber.

4. The nozzle assembly according to claim 3, wherein the outlet conduit, the rear sub-chamber, the liquid inlet, the front sub-chamber, the dividing member, and the air inlet conduit are configured such that after the pressurized air is introduced into the air inlet conduit and the liquid is introduced into the liquid inlet, the second mist produced in the front sub-chamber is accelerated to supersonic speeds in the nozzle outlet conduit.

5. The nozzle according to claim 1, wherein the air inlet conduit is cylindrical and has a diameter and a length, the diameter of the air inlet conduit being equal to or less than one-half the length of the air inlet conduit.

6. The nozzle according to claim 1, wherein the outlet conduit is cylindrical and has a diameter and a length, the diameter of the outlet conduit being equal to or less than one-half the length of the outlet conduit.

7. The nozzle according to claim 1, wherein the air inlet conduit has a first cross-sectional area and the outlet conduit has a second cross-sectional area, the second cross-sectional area being greater than the first cross-sectional area.

8. The nozzle according to claim 1, wherein the first and second fluid passages of the dividing member respectively comprise a first axial groove and a second axial groove formed in an outer wall of the dividing member.

9. The nozzle according to claim 1, wherein the first and second fluid passages of the dividing member respectively comprise a first axial through hole and a second axial through hole.

10. The nozzle assembly according to claim 1, wherein the dividing member is in the form of a disk.

11. The nozzle assembly according to claim 1, wherein the dividing member is capable of assuming multiple axial positions for the purpose of altering the volume of the front and rear sub-chambers.

12. The nozzle assembly according to claim 1, further comprising a radial bore through which the pressurized air is delivered to the air inlet conduit, the radial bore having a first diameter, the air inlet conduit having a second diameter less than the first diameter.

13. The nozzle assembly according to claim 1, wherein the front sub-chamber is delimited by a back face of a plug, the outlet conduit extending through a portion of the plug.

14. The nozzle assembly according to claim 13, further comprising a handle that can be manipulated by a user, the plug being attached to a front end of the handle, a front face of the plug and the front end of the handle being flush with one another.

15. The nozzle assembly according to claim 14, wherein the plug and handle are attached by a threaded connection.

16. The nozzle assembly according to claim 13, wherein the outlet conduit is disposed between a cone-shaped hole and a conic outlet mouth that are each formed in the plug, each of the cone-shaped hole and the conic outlet mouth having a central axis that are axially aligned.

17. The nozzle assembly according to claim 1, further comprising a connector part through which the pressurized air and liquid are supplied, the connector part having a first conduit in fluid communication with the liquid inlet and a second conduit in fluid communication with the air inlet conduit.

18. The nozzle assembly according to claim 17, wherein the connector part is a monolithic structure.

19. The nozzle assembly according to claim 13, further comprising a connector part through which the pressurized air and liquid are supplied, the connector part having a first conduit in fluid communication with the liquid inlet and a second conduit in fluid communication with the air inlet conduit, the connector part being coupled to the plug by a fast connector.

20. The nozzle assembly according to claim 17, further comprising a flexible coaxial hose coupled to the connector part, the coaxial hose having an inner conduit and an outer conduit surrounding the inner conduit, one of the inner and outer conduits being in fluid communication with the first conduit of the connector part, the other of the inner and outer conduits being in fluid communication with the second conduit of the connector part.
